(19) United States
(12) Patent Application Publication
(10) Pub. No.: US 2004/0252076 A1
(43) Pub. Date: Dec. 16, 2004

(54) Display device, electronic device and display method

(76) Inventor: Yoshiyuki Kodama, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/812,404

(22) Filed: Mar. 26, 2004

(30) Foreign Application Priority Data
Mar. 31, 2003 (JP) 2003-097506

(51) Int. Cl. G09G 5/00

(52) U.S. Cl. 345/3.1

(57) ABSTRACT

A display device is provided to display in full color and with reduced power consumption. The display device includes an organic EL display disposed on a display screen side (front surface side) and an electrophoresis panel disposed on a rear surface side. The organic EL display includes an organic EL emission layer that emits color lights in response to an applied voltage and a pair of transparent electrodes disposed so as to sandwich the organic EL emission layer. The electrophoresis panel includes a layer disposed with microcapsules that display in black and white in response to an applied voltage.

### RELATED APPLICATIONS

This application claims priority to Japanese Patent Application No. 2003-097506 filed Mar. 31, 2003 which is hereby expressly incorporated by reference herein in its entirety.

### BACKGROUND OF THE INVENTION

1. Technical Field

The present invention relates to a display device for displaying contents and the like of digitized documents (electronic books), an electronic device using the display device, and a display method.

2. Related Art

Conventionally, as this type of technology, an electrophoresis panel is known where plural microcapsules filled with liquid dispersion mediums colored to any of, for example, cyan, magenta and yellow, and positively or negatively charged white charged particles are sandwiched between a pair of transparent electrodes. In this electrophoresis panel, a voltage is applied to optional microcapsules to migrate the charged particles to a rear surface side, and causes a front surface side to display mixed colors of the liquid dispersion mediums of the microcapsules, whereby color display data, such as a color photograph, included in the contents is displayed (see JP2000-35598A).

An organic electroluminescence (EL) display is also known where an organic EL emission layer in which one pixel is comprised of a set of three sub-pixels that emit, for example, red, green and blue light is sandwiched between a pair of transparent electrodes. In this organic EL display, a voltage is applied to the organic EL emission layer to emit color lights and display mixed colors of the color lights, whereby color display data included in the contents is displayed.

However, in the case of the former of the above-described conventional technologies, it has been difficult for the panel to display in full color because the panel displays color display data with a mixture of cyan, magenta and yellow, i.e., the three primary colors with which accurate color reproduction is relatively difficult. There has also been the problem that the panel cannot be seen in dark places because of the reflective display.

In the case of the latter display, the display can relatively easily display in full color because the display displays color display data with a mixture of red, green and blue, i.e., the three primary colors with which accurate color reproduction is relatively easy, but the amount of power consumed in emission of the color lights has been large.

Thus, it is an object of the present invention to solve the unsolved problems of the above-described conventional technologies and to provide a display device that can easily display in full color and reduce power consumption, and an electronic device and a display method which use the display device.

### SUMMARY

In order to achieve this object, a display device according to an aspect of the invention includes a first display disposed on a display screen side; and a second display disposed on a rear surface side, the first display including a self-luminous layer that self-emits desired color lights in response to a first applied voltage and a pair of transparent electrodes disposed so as to sandwich the self-luminous layer, and the second display including an electrophoresis layer that displays two colors in response to a second applied voltage.

By configuring the invention in this manner, the color lights of the first display are displayed superposed on the two-color display of the second display. Thus, for example, the first display is made to emit color lights of red, green and blue (RGB) to display color display data included in display contents in the mixed colors of these, and the second display is made to display monochromatic display data included in the display contents, whereby the display contents can be easily displayed in full color, the power consumed in emission of the color lights by the first display can be reduced, and the power consumption of the overall display device can be reduced.

Also, in the display device according to the invention, the two-color display may be a black-and-white display.

By configuring the invention in this manner, the difference in brightness of the two colors becomes large. Thus, the borders of the two-color display can be distinctly perceived and the display contents can be made easy to see.

Moreover, in the display device according to the invention, the self-luminous layer may be an organic electroluminescence layer.

By configuring the invention in this manner, the speed at which the contents are displayed by the first display can be increased, and a moving image can be displayed as the display contents.

Also, the display device according to the invention may further include control means that controls the display states of the first display and the second display.

By configuring the invention in this manner, the display states of the first display and the second display can be changed on the basis of the content and surrounding environment of the display contents, and the display contents can be appropriately displayed.

Also, in order to solve the above-described problem, a display device according to an aspect of the invention includes a first display disposed on a display screen side; a second display disposed on a rear surface side, the first display including a self-luminous layer that self-emits desired color lights in response to a first applied voltage and a pair of transparent electrodes disposed so as to sandwich the self-luminous layer, and the second display including a reflective display layer that displays two colors in response to a second applied voltage; and control means that controls the display states of the first display and the second display, wherein the control means causes the first display to display color display data included in display contents and causes the second display to display monochromatic display data included in the display contents.

Also, in the display device according to the invention, the control means may cause the first display to display color display data included in the display contents and cause the second display to display monochromatic display data included in the display contents.

By configuring the invention in this manner, for example, the first display is made to emit color lights of red, green and blue (RGB) to display color display data included in the display contents in the mixed colors of these, whereby the color display data can be easily displayed in full color.

Moreover, in the display device according to the invention, the control means may cause the first display to display color photographic data included in the display contents and cause the second display to display monochromatic photographic data and character data included in the display contents.

By configuring the invention in this manner, for example, the first display is made to emit color lights of red, green and blue (RGB) to display color photographic data included in the display contents in the mixed colors of these, whereby the color photographic data can be easily displayed in full color.

Moreover, in the display device according to the invention, the control means may cause the first display to display the color display data included in the display contents and display, in a dark color, a portion of the second display superposed on a display region of the color display data.

By configuring the invention in this manner, the brightness of the first display can be reduced because the area surrounding the color display data becomes dark, and the amount of power consumed in emission of the color lights can be further reduced without compromising the ease with which the display contents can be seen.

In the display device according to the invention, the control means may cause the second display to display the character data included in the display contents and set, to a light-emitting state, a portion of the first display superposed on a bright color display region of the character data or a portion of the first display substantially superposed on the bright color display region of the character data.

By configuring the invention in this manner, the difference in brightness between a bright color display region and a dark color display region of the character data included in the display contents (i.e., the display region of the characters and the display region of the background portion) becomes large, whereby the borders of these regions can be distinctly perceived and the character data can be made easy to see. Also, the characters can be read even in a dark environment.

The display device according to the invention may also include mode selection means with which it is possible for a user to select a power-saving mode, wherein when the power-saving mode is selected, the control means causes the second display to also display, in two colors, the color display data included in the display contents.

By configuring the invention in this manner, for example, the emission of the color lights by the first display can be stopped when the power-saving mode has been selected by the user, so that the power consumption of the overall display device can be further reduced.

Also, the display device according to the invention may be configured so that, when the state where the first display is displaying the color display data included in the display contents passes a set amount of time, the control means automatically moves to a state where the second display is allowed to display, in two colors, the color display data.

By configuring the invention in this manner, for example, the emission of the color lights by the first display can be stopped when the state where the color display data is being displayed on the first display has passed the set amount of time, so that the power consumption of the overall display device can be further reduced.

Moreover, the display device according to the invention may further include incident light amount detecting means that detects the amount of light incident to the display screen, wherein the control means controls the brightness of the first display in response to the incident light amount.

By configuring the invention in this manner, for example, the brightness of the first display can be reduced when the amount of light incident to the display screen is small (i.e., when the surrounding area is dark), so that the power consumed in emission of the color lights can be further reduced without compromising the ease with which the display contents can be seen.

Also, an electronic device according to the invention includes the display device as recited in any of the above.

By configuring the electronic device in this manner, the color lights of the first display are displayed superposed on the two-color display of the second display. Thus, for example, the first display is made to emit color lights of red, green and blue (RGB) and display a predetermined portion of display contents in the mixed colors of these, and the second display is made to display the remaining portion of the display contents, whereby the predetermined portion of the display contents can be displayed in full color, the power consumed in emission of the color lights by the first display can be reduced, and the power consumption of the overall display device can be reduced.

Also, a display method according to one aspect of the invention includes disposing a reflective display on a rear surface side of a self-luminous transmissive display, causing the transmissive display to display color display data included in the display contents, and causing the reflective display to display monochromatic display data included in the display contents.

Also, the display method according to the invention may be one where the transmissive display is made to display color photographic data included in the display contents and the reflective display is made to display monochromatic photographic data and character data included in the display contents.

Moreover, the display method according to the invention may cause the transmissive display to display the color display data included in the display contents and display a portion of the reflective display superposed on a display region of the color display data in a dark color.

Also, the display method according to the invention may cause the reflective display to display the character data included in the display contents and set a portion of the transmissive display superposed on a bright color display region of the character data or a portion of the first display substantially superposed on the bright color display region of the character data to a light-emitting state.

Moreover, in the display method according to the invention, when a power-saving mode is selected by a user, the reflective display may also be made to display, in two colors, the color display data included in the display contents.

Moreover, in the display method according to the invention, when the state where the transmissive display is being made to display the color display data included in the display contents passes a set amount of time, the state may be automatically moved to a state where the reflective display is made to display, in two colors, the color display data.

### BRIEF DESCRIPTION OF THE DRAWINGS

FIG. 1 is a schematic configuration diagram showing an embodiment of a display device of the invention.

FIG. 2 is a cross-sectional diagram showing an enlarged cross section of a display screen in FIG. 1.

FIG. 3 is an explanatory diagram for describing a display state of display contents.

FIGS. 4A and B are explanatory diagrams for describing a color-1 mode.

FIGS. 5A and B are explanatory diagrams for describing a color-2 mode.

FIGS. 6A and B are explanatory diagrams for describing a monochromatic auto illumination mode.

FIGS. 7A and B are explanatory diagrams for describing a low-power monochromatic mode.

FIG. 8 is a block diagram showing the configuration of a control device.

FIG. 9 is a flow chart of contents display processing.

FIG. 10 is a flow chart of timer interruption processing.

FIG. 11 is a flow chart of termination processing.

FIGS. 12A and B are explanatory diagrams for describing a modified example.

### DETAILED DESCRIPTION

An embodiment of an electronic book reader for browsing the contents of an electronic book will be described below as an electronic device equipped with a display device according to the invention with reference to the drawings.

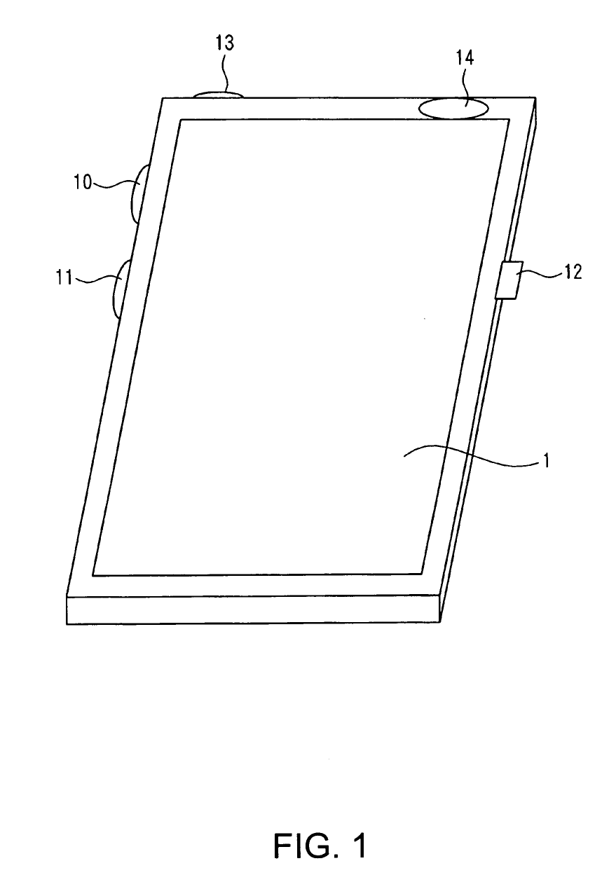

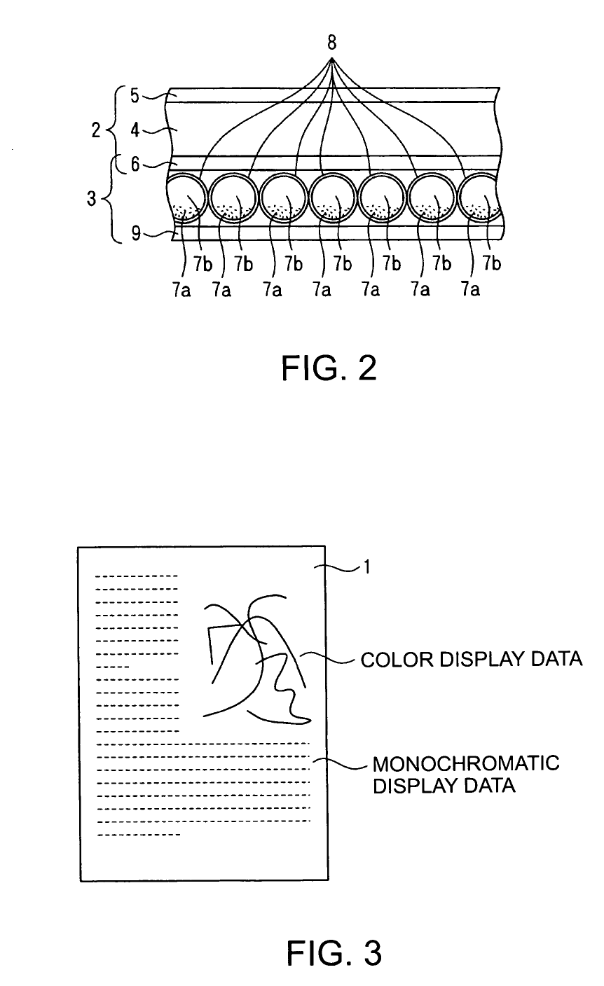

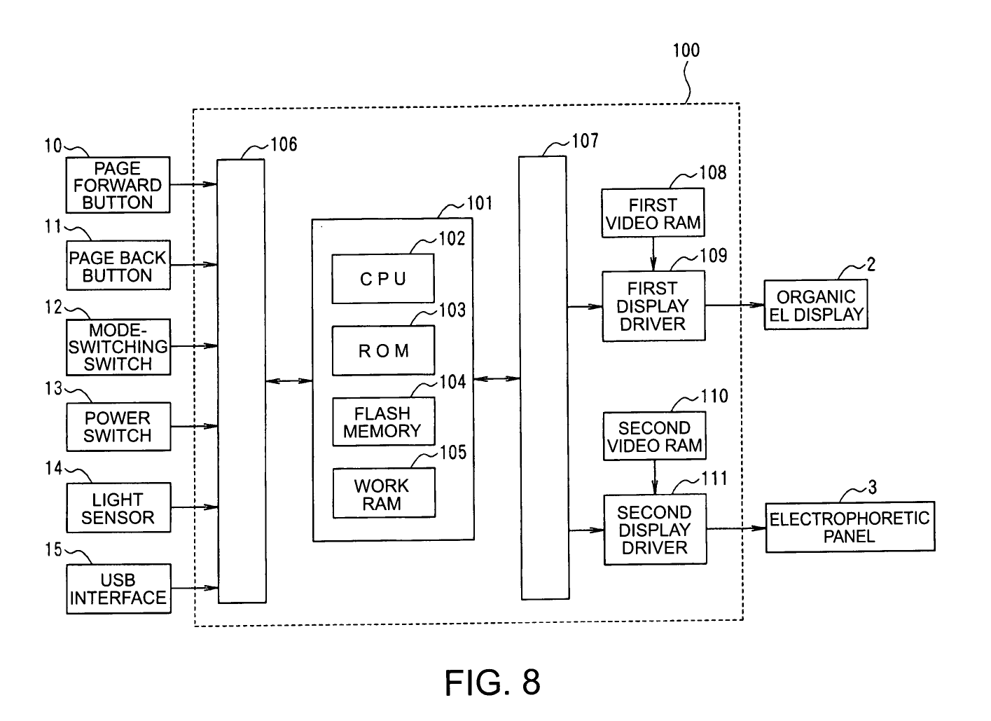

FIG. 1 is a schematic configuration diagram showing an embodiment of the invention. In FIG. 1, a display screen 1 is provided for displaying the contents of the electronic book divided into predetermined pages. As shown in FIG. 2, an organic EL (organic electroluminescence) display 2 that self-emits color lights is disposed on a front surface side (display screen side) of the display screen 1, and an electrophoresis panel 3 that displays in black and white is disposed on a rear surface side of the display screen 1. The organic EL display 2 includes an organic EL emission layer 4 in which one pixel is comprised of a set of three sub-pixels that emit, for example, red, green and blue lights and a pair of transparent electrodes 5 and 6 that are disposed so as to sandwich the organic EL emission layer 4. Of these transparent electrodes 5 and 6, the electrode (pixel electrode) 5 at the front surface side and the organic EL emission layer 4 are formed in a matrix, and the electrode 6 at the rear surface side serves as a shared electrode of the entire display surface. A voltage is applied to the organic EL emission layer 4 in accordance with a command from a later-described control device 100 (see FIG. 8) via a first display driver 109 (see FIG. 8) and a drive circuit (omitted from the drawings), so that the organic EL emission layer 4 is caused to self-emit color lights to allow mixed colors of these color lights to be recognized from the front surface side, and color display data, such as a color photograph, included in the display contents is displayed.

The electrophoresis panel 3 includes plural microcapsules 8, which encapsulate electrophoresis dispersion liquids 7 comprising black charged particles 7a and white dispersion medium 7b, and a pair of electrodes 6 and 9 that are disposed so as to sandwich the layer in which the microcapsules 8 are disposed. Of these electrodes 6 and 9, the electrode 6 at the front surface side serves as a shared electrode of the entire panel surface, and the electrode 9 at the rear surface side is formed in a matrix. A voltage is applied to optional microcapsules 8 in accordance with a command from the later-described control device (see FIG. 8) via a second display driver 111 (see FIG. 8) and a drive circuit (omitted from the drawings), whereby the black charged particles 7a are adsorbed to the front surface side (electrode 6 side), the charged particles 7a are recognized from the front surface side, and monochromatic display data, such as a monochromatic photograph and characters, included in the display contents is displayed. Also, because a charge is retained in the electrode 9 when the electrophoresis panel 3 is switched OFF from this state (i.e., when the drive circuit is switched to an open state), the charged particles 7a are absorbed to the electrode 6 side by the Coulomb force of the charge retained in the electrode. In other words, in a state where no energy is being supplied, a state where the charged particles 7a are absorbed is maintained and the monochromatic display data continues to be displayed on the front surface side. It should be noted that the electrode 6 of the front surface side of the electrophoresis panel 3 also serves as the transparent electrode 6 of the rear surface side of the organic EL display 2.

As shown in FIG. 3, the monochromatic display data displayed on the front surface side of the electrophoresis panel 3 is viewable from the front surface side of the display screen 1 through the organic EL display 2, and a display (i.e., the contents of the electronic book) where the color display data displayed on the organic EL display 2 is superposed on the monochromatic display data displayed on the electrophoresis panel 3 is displayed on the display screen 1.

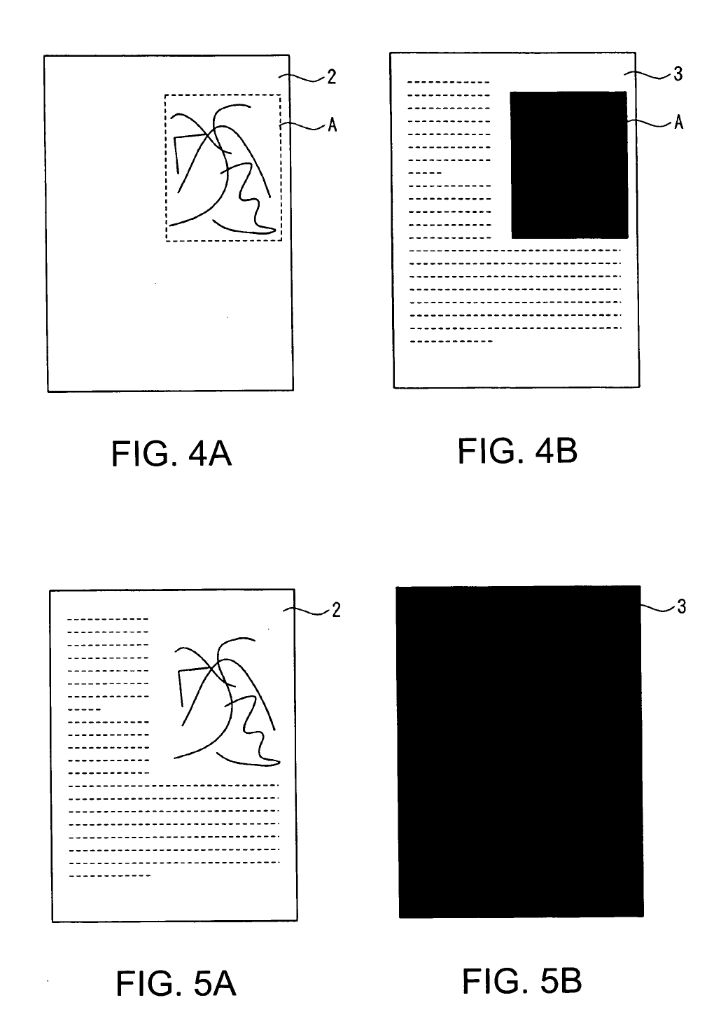

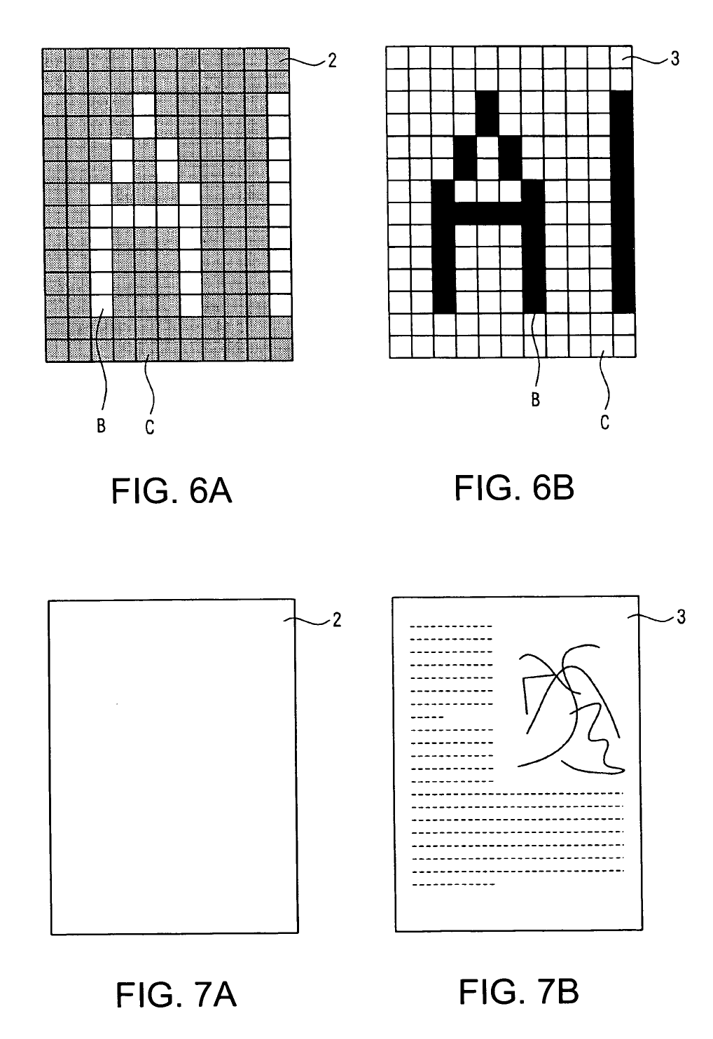

At the left side of the display screen 1 are disposed a page forward button 10 that causes the display screen 1 to display the contents of the next page and a page back button 11 that causes the display screen 1 to display the contents of the previous page. The operational states of the buttons 10 and 11 are outputted to the control device 100 (see FIG. 8). At the right side of the display screen 1 is disposed a mode-switching switch 12 for switching operation modes of the electronic book. The operational state of the switch 12 is outputted to the control device 100 (see FIG. 8). The mode-switching switch 12 enables the display to be switched between four operation modes: a color-1 mode that causes the organic EL display 2 to display the color display data and causes the electrophoresis panel 3 to display the monochromatic display data, as shown in FIGS. 4A and 4B; a color-2 mode that causes the organic EL display 2 to display all display data included in the display contents, as shown in FIGS. 5A and 5B; a monochromatic auto illumination mode that causes the electrophoresis panel 3 to display all display data included in the display contents and causes the organic EL display to emit white light, as shown in FIGS. 6A and 6B; and a low-power monochromatic mode that causes the electrophoresis panel 3 to display all display data included in the display contents and switches the organic EL display 2 OFF, as shown in FIGS. 7A and 7B.

Moreover, at the upper left side of the display screen 1 is disposed a power switch 13 that switches the power of the electronic book reader OFF, i.e., switches the drive circuit of the organic EL display 2 and the drive circuit of the electrophoresis panel 3 into an open state. The operational state of the power switch 13 is outputted to the control device 100 (see FIG. 8). Also, a light sensor 14 that detects the amount of light incident to the display screen 1 is disposed at the upper right side of the display screen 1. The detection result is outputted to the control device 100 (see FIG. 8).

Next, the configuration of the control device 100 will be described in accordance with the block diagram of FIG. 8. In the drawing, a main control unit 101 is provided including a microprocessor incorporating a CPU 102, a ROM 103 that stores a control program and the like, a flash memory 104 that stores display data and the like included in the contents of the electronic book, and a work RAM 105 forming respective types of work areas.

The page forward button 10, the page back button 11, the mode-switching switch 12, the power switch 13, the light sensor 14 and a USB interface 15 that is connected to an external device to read new display data are connected to an input port 106 of the main control unit 101. A first video RAM 108 that stores display data to be displayed on the organic EL display 2, the first display driver 109 for driving the organic EL display 2, a second video RAM 110 that stores display data to be displayed on the electrophoresis panel 3 and the second display driver 111 for driving the electrophoresis panel 3 are connected to an output port 107 of the main control unit 101. The control device 100 executes contents display processing that causes the organic EL display 2 or the electrophoresis panel 3 to display the contents of the previous page or the next page when the page forward button 10 or the page back button 11 has been operated, timer interruption processing that is executed each time a predetermined amount of time AT (e.g., 10 msec.) elapses, and termination processing that switches the organic EL display 2 and the electrophoresis panel 3 OFF when the power switch 13 is switched OFF.

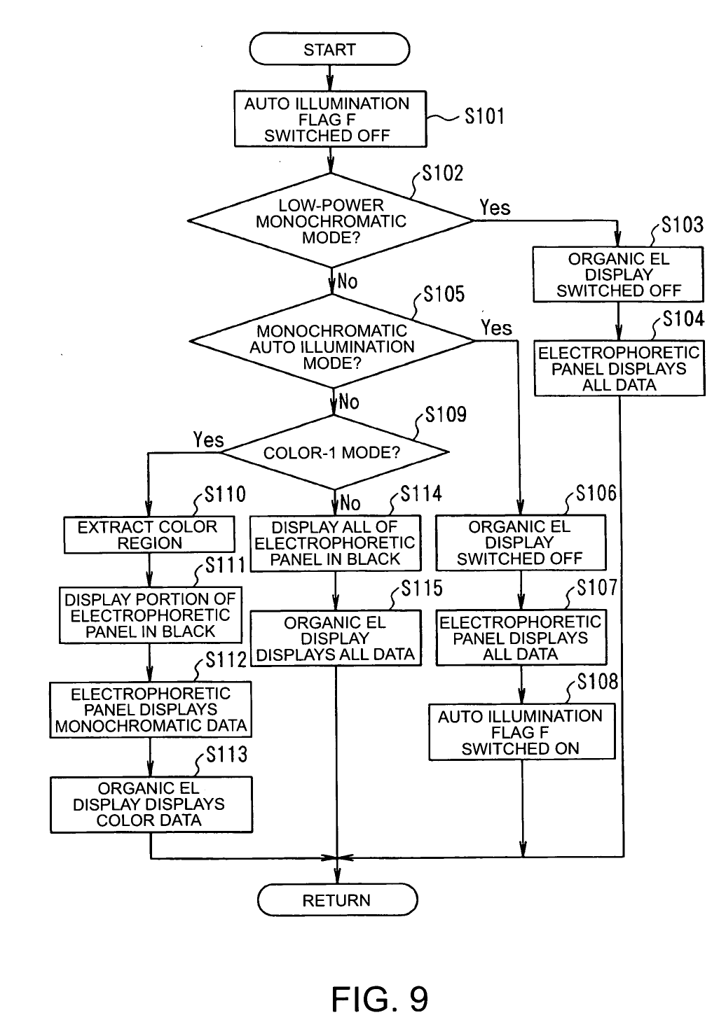

Next, the contents display processing that causes the contents of the electronic book to be displayed on the organic EL display 2 or the electrophoresis panel 3 on the basis of a detection signal acquired from the page forward button 10 or the page back button 11 will be described in accordance with the flow chart of FIG. 9. The contents display processing is processing that is executed when the page forward button 10 or the page back button 11 has been operated. First, in step S101 thereof, an auto illumination flag F is set to an OFF state of “0”.

Next, the processing moves to step S102, where it is determined whether or not the mode-switching switch 12 is set to the low-power monochromatic mode. If the mode-switching switch 12 is set to the low-power monochromatic mode (“Yes”), the processing moves to step S103, and if the mode-switching switch 12 is not set to the low-power monochromatic mode (“No”), the processing moves to step S105.

In step S103, a command that switches the organic EL display 2 OFF (i.e., switches the drive circuit to an open state) is outputted to the first display driver 109, as shown in FIG. 7A.

Next, the processing moves to step S104, where all display data included in the contents of a predetermined page is displayed in black and white on the electrophoresis panel 3, as shown in FIG. 7B. Specifically, when the page forward button 10 has been operated, a command that causes the electrophoresis panel 3 to display, in black and white, all display data included in the contents of the next page is outputted to the second display driver 111, and when the page back button 11 has been operated, a command that causes the electrophoresis panel 3 to display, in black and white, all display data included in the contents of the previous page is outputted to the second display driver 111.

In step S105, on the other hand, it is determined whether or not the mode-switching switch 12 is set to the monochromatic auto illumination mode. If the mode-switching switch 12 is set to the monochromatic auto illumination mode (“Yes”), the processing moves to step S106, and if the mode-switching switch 12 is not set to the monochromatic auto illumination mode (“No”), the processing moves to step S109.

In step S106, a command that switches the organic EL display 2 OFF (i.e., switches the drive circuit to an open state) is outputted to the first display driver 109, as shown in FIG. 6A.

Next, the processing moves to step S107, where all display data included in the contents of a predetermined page is displayed in black and white on the electrophoresis panel 3, as shown in FIG. 6B. Specifically, when the page forward button 10 has been operated, a command that causes the electrophoresis panel 3 to display, in black and white, all display data included in the contents of the next page is outputted to the second display driver 111, and when the page back button 11 has been operated, a command that causes the electrophoresis panel 3 to display, in black and white, all display data included in the contents of the previous page is outputted to the second display driver 111.

Next, the processing moves to step S108, where the auto illumination flag is switched to an ON state of “1” and this calculation processing ends.

In step S109, on the other hand, it is determined whether or not the mode-switching switch 12 is set to the color-1 mode. If the mode-switching switch 12 is set to the color-1 mode (“Yes”), the processing moves to step S10, and if the mode-switching switch 12 is not set to the color-1 mode (“No”), it is deemed that the mode-switching switch 12 is set to the color-2 mode and the processing moves to step S114.

In step S110, when the page forward button 10 has been operated, the display data included in the contents of the next page is read from the flash memory 104 and a display region A of the color display data is extracted from the display data as shown in FIG. 4A. When the page back button 11 has been operated, the display data included in the contents of the previous page is read from the flash memory 104 and the display region A of the color display data is extracted from the display data.

Next, the processing moves to step S111, where a command that causes the electrophoresis panel 3 to black out and display the portion superposed on the display region A of the color display data extracted in step S110, as shown in FIG. 4B, is outputted to the second display driver 111.

Next, the processing moves to step S112, where a command that causes the electrophoresis panel 3 to display, in black and white, display data excluding the color display data extracted in step S110 (i.e., the monochromatic display data), as shown in FIG. 4B, is outputted to the second display driver 111.

Next, the processing moves to step S113, where a command that causes the organic EL display 2 to display, in color, the color display data extracted in step S110, as shown in FIG. 4A, is outputted to the second display driver 111.

In step S114, on the other hand, a command that causes the electrophoresis panel 3 to be completely blacked out, as shown in FIG. 5B, is outputted to the second display driver 111.

Next, the processing moves to step S115, where the organic EL display 2 is made to display all display data included in the contents of a predetermined page, as shown in FIG. 5A. Specifically, when the page forward button 10 has been operated, a command that causes the organic EL display 2 to display, in color, all display data included in the contents of the next page is outputted to the first display driver 109, and when the page back button 11 has been operated, a command that causes the organic EL display 2 to display, in color, all display data included in the contents of the previous page is outputted to the first display driver 109.

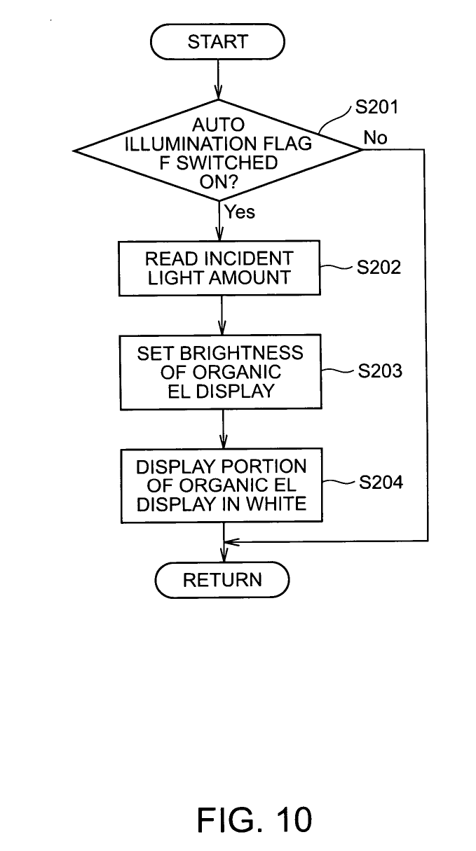

Next, the timer interruption processing that is executed each time the predetermined amount of time AT elapses will be described in accordance with the flow chart of FIG. 10. When the timer interruption processing is executed, it is first determined in step S201 whether or not the auto illumination flag F is in the ON state of “1”. If the auto illumination flag F is in the ON state (“Yes”), the processing moves to step S202, and if the auto illumination flag F is not in the ON state (“No”), this calculation processing ends.

In step S202, the amount of light incident to the display screen 1 and detected by the light sensor 14 is read.

Next, the processing moves to step S203, where the brightness of the organic EL display 2 is set from the incident light amount read in step S202. Specifically, a command that makes the brightness of the organic EL display 2 lower as the amount of light incident to the display screen 1 becomes smaller (i.e., as the surrounding area becomes darker) is outputted to the first display driver 109.

Next, the processing moves to step S204, where a bright color display region C (i.e., a display region C of a background portion of characters) is extracted from character data B included in the contents being displayed on the electrophoresis panel 3, as shown in FIG. 6A, and a command that causes the organic EL display 2 to display in white and with the brightness set in step S203, the portion superposed on the display region C is outputted to the first display driver 109.

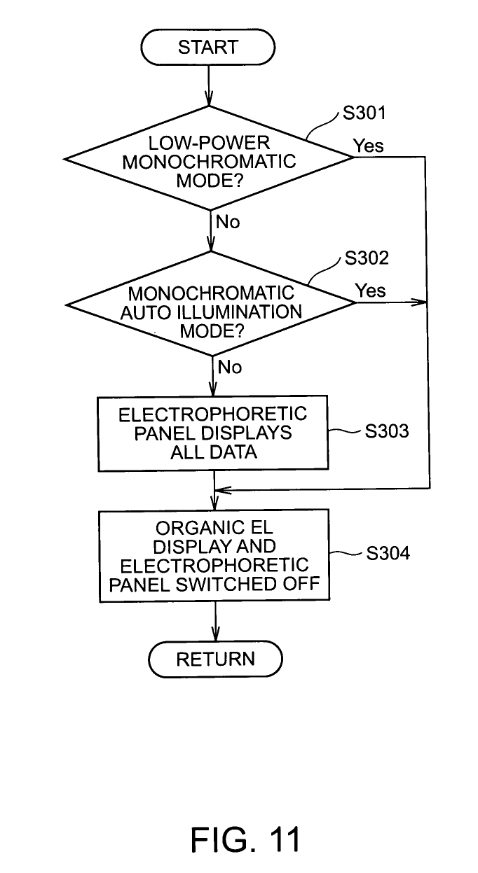

Next, the termination processing that switches the organic EL display 2 and the electrophoresis panel 3 OFF on the basis of the detection signal acquired from the power switch 13 will be described in accordance with the flow chart of FIG. 11. This termination processing is processing that is executed when the power switch 13 is switched OFF. First, in step S301, it is determined whether or not the mode-switching switch 12 is set to the low-power monochromatic mode. If the mode-switching switch 12 is set to the low-power monochromatic mode (“Yes”), then the processing moves to step S304. If the mode-switching switch 12 is not set to the low-power monochromatic mode “No”, the processing moves to step S302.

In step S302, it is determined whether or not the mode-switching switch 12 is set to the monochromatic auto illumination mode. If the mode-switching switch 12 is set to the monochromatic auto illumination mode (“Yes”), then the processing moves to step S304. If the mode-switching switch 12 is not set to the monochromatic auto illumination mode “No”, it is deemed that the display is set in the color-1 mode or the color-2 mode and the processing moves to step S303.

In step S303, a command that causes the electrophoresis panel 3 to display, in black and white, all display data of the contents that had been displayed on the organic EL display 2 and the electrophoresis panel 3 is outputted to the second display driver 111 and the processing moves to step S304.

In step S304, the power of the electronic book reader is switched OFF (i.e., the drive circuit of the organic EL display 2 and the drive circuit of the electrophoresis panel 3 are switched to an open state) and this calculation processing ends.

Next, the operation of the electronic book reader of the present embodiment will be described specifically.

First, it is assumed that a user has set the mode-switching switch 12 to the color-1 mode and operated the page forward button 10. When this happens, the contents display processing is executed in the control device 100, the auto illumination flag F is switched to the OFF state of “0” in step S101, the determination in steps S102 and S105 becomes “No”, the determination in step S109 becomes “Yes”, the display data included in the contents of the next page is read from the flash memory 104 and the display region A of the color display data is extracted from the display data in step S110 as shown in FIG. 4A, a command that causes the electrophoresis panel 3 to black out the portion superposed on the display region A of the color display data as shown in FIG. 4B is outputted to the second display driver 111 in step S11, a command that causes the electrophoresis panel 3 to display, in black and white, the monochromatic display data as shown in FIG. 4B is outputted to the second display driver 111 in step S112, and a command that causes the organic EL display 2 to display, in color, the color display data as shown in FIG. 4A is outputted to the first display driver 109 in step S113. When these commands are outputted to the first display driver 109 and the second display driver 111, color photographic data is displayed in color by the organic EL display 2 as shown in FIG. 4A, the portion superposed on the display region A of the color photographic data is blacked out on the electrophoresis panel 3 as shown in FIG. 4B, character data is displayed in black and white and, as shown in FIG. 3, a display where the color photographic data displayed on the organic EL display 2 is superposed on the character data displayed in black and white on the electrophoresis panel 3 is displayed on the display screen 1.

In this manner, in the present embodiment, color lights of red, green and blue (RGB) are emitted by the organic EL display 2, the color photographic data included in the display contents is displayed in mixed colors of these and the character data included in the display contents is displayed in black and white by the electrophoresis panel 3. Thus, a color photograph is easily displayed in full color, the amount of power consumed in emission of the color lights by the organic EL display 2 is reduced, and the power consumption of the overall device is reduced. Also, because the difference in brightness between the characters and the background portion increases due to the two-color display of black and white, the borders between these can be distinctly perceived and it becomes easy to see the display contents. Moreover, because the area surrounding the color display data becomes dark, the brightness of the organic EL display 2 can be reduced and the amount of power consumed in emission of the color lights can be further reduced without compromising the ease with which the display contents can be seen.

Again, it is assumed that a user has set the mode-switching switch 12 to the color-2 mode and operated the page forward button 10. When this happens, the contents display processing is executed in the control device 100, the processing passes through step S101, the determination in steps S102 to S109 becomes “No”, a command that causes all of the electrophoresis panel 3 to become black as shown in FIG. 5B is outputted to the second display driver 111 in step S114, and a command that causes the organic EL display 2 to display, in color, all display data included in the contents of the next page as shown in FIG. 5A is outputted to the first display driver 109 in step S115. When these commands are outputted to the first display driver 109 and the second display driver 111, all display data is displayed in color on the organic EL display 2 as shown in FIG. 5A, all of the electrophoresis panel 3 is blacked out as shown in FIG. 5B, and all display data displayed in color on the organic EL display 2 is displayed on the display screen 1 as shown in FIG. 3.

In this manner, in the present embodiment, all display data is displayed by the organic EL display 2 when the mode-switching switch 12 is set to the color-2 mode. Thus, the speed at which the contents are displayed is increased, many contents are displayed in a short period of time and desired contents can be searched. Also, because the area surrounding the color display data becomes dark, the brightness of the organic EL display 2 can be reduced and the amount of power consumed in emission of the color lights can be further reduced without compromising the ease with which the display contents can be seen.

Again, it is assumed that a user has set the mode-switching switch 12 to the low-power monochromatic mode and operated the page forward button 10. When this happens, the contents display processing is executed in the control device 100, the processing first passes through step S101, the determination in step S102 becomes “Yes”, a command that switches the organic EL display 2 OFF as shown in FIG. 7A is outputted to the first display driver 109 in step S103, and a command that causes the electrophoresis panel 3 to display, in black and white, all display data of the contents included in the next page as shown in FIG. 7B is outputted to the second display driver 111 in step S104. When these commands are outputted to the first display driver 109 and the second display driver 111, the organic EL display 2 is switched OFF as shown in FIG. 7A, all display data included in the contents of the next page is displayed in black and white on the electrophoresis panel 3 as shown in FIG. 7B, and all display data displayed in black and white on the electrophoresis panel 3 is displayed on the display screen 1 as shown in FIG. 3.

In this manner, in the present embodiment, when the low-power monochromatic mode has been selected by the user, emission of the color lights by the organic EL display 2 is stopped, so that the color display data included in the display contents is also displayed in black and white on the electrophoresis panel 3 the power consumption of the overall device is further reduced.

Again, it is assumed that a user has set the mode-switching switch 12 to the monochromatic auto illumination mode and operated the page forward button 10. When this happens, the contents display processing is executed in the control device 100, the processing first passes through step S101, the determination in step S102 becomes “No”, the determination in step S105 becomes “Yes”, a command that switches the organic EL display 2 OFF is outputted to the first display driver 109 in step S106, a command that causes the electrophoresis panel 3 to display, in black and white, all display data included in the contents of the next page as shown in FIG. 6B is outputted to the second display driver 111 in step S107, and the auto illumination flag is set to the ON state of “1” in step S108. When these commands are outputted to the first display driver 109 and the second display driver 111, the organic EL display 2 is switched OFF, all display data included in the contents of the next page is displayed in black and white on the electrophoresis panel 3 as shown in FIG. 6B, and all display data displayed in black and white on the electrophoresis panel 3 is displayed on the display screen 1 as shown in FIG. 3.

Here, it is assumed that the timer interruption processing has been executed. When this happens, first, the determination in step S201 becomes “Yes”, the amount of light incident to the display screen 1 and detected by the light sensor 14 is read in step S202, the brightness of the organic EL display 2 is set from the incident light amount in step S203, the bright color display region C is extracted from the character data B included in the contents being displayed on the electrophoresis panel 3 as shown in FIG. 6A, and a command that causes the organic EL display 2 to display, in white, the portion superposed on the display region C is outputted to the first display driver 109 in step S204. When this command is outputted to the first display driver 109, the portion superposed on the display region C of the background portion of the characters is displayed in white on the organic EL display 2 as shown in FIG. 6A, and the difference in brightness between the display region C of the background portion and the display region B of the characters of all display data displayed in black and white on the electrophoresis panel 3 is largely displayed on the display screen 1.

In this manner, in the present embodiment, because the difference in brightness between the display region B of the characters and the display region C of the background portion is enlarged, the borders between these display regions B, C can be distinctly perceived and it becomes easy to see the character data even when the amount of light incident to the display screen 1 is small.

Also, because the brightness of the organic EL display 2 is reduced when the amount of light incident to the display screen 1 is small (i.e., when the surrounding area is dark), the amount of power consumed in emission of the color lights can be further reduced without compromising the ease with which the display contents can be seen.

Again, it is assumed that a user has set the mode-switching switch 12 to the color-1 mode and switched the power switch 13 OFF. When this happens, the termination processing is executed in the control device 100, first, the determination in steps S301 and S302 becomes “No”, a command that causes the electrophoresis panel 3 to display, in black and white, all display data included in the contents that had been displayed on the organic EL display 2 and the electrophoresis panel 3 is outputted to the second display driver 111 in step S303, and the drive circuit of the organic EL display 2 and the drive circuit of the electrophoresis panel 3 are switched to an open state in step S304. When these commands are outputted to the first display driver 109 and the second display driver 111, the drive circuit of the organic EL display 2 and the drive circuit of the electrophoresis panel 3 are switched to the open state after all display data included in the contents has been displayed in black and white on the electrophoresis panel 3, and all display data that had been displayed in black and white on the electrophoresis panel 3 continues to be displayed on the display screen 1 as shown in FIG. 3.

It should be noted that, in the above-described embodiment, the organic EL display 2 corresponds to a first display and a transmissive display, the electrophoresis panel 3 corresponds to a second display and a reflective display, the organic EL emission layer 4 corresponds to a self-luminous layer, the layer in which the microcapsules 8 are disposed corresponds to an electrophoresis layer, the control device 100 corresponds to control means, the low-power monochromatic mode corresponds to a power-saving mode, the mode-switching switch 12 corresponds to mode selection means, and the light sensor 14 corresponds to incident light amount detecting means.

Also, the foregoing description of the embodiment has described an example of the display device and the electronic device of the invention and does not limit the configuration or so of the display device.

For example, although the foregoing description of the embodiment has described an example where the color display data included in the contents is displayed in black and white on the electrophoresis panel 3 when the mode-switching switch 12 is set to the low-power monochromatic mode, the invention is not limited thereto. The invention may also be configured to automatically move to a state where the color display data is displayed in black and white on the electrophoresis panel 3 when a state where the color display data included in the contents is being displayed on the organic EL display 2 passes a set amount of time. By configuring the invention in this manner, the emission of the color lights by the organic EL display 2 can be stopped and the power consumption of the overall device can be further reduced.

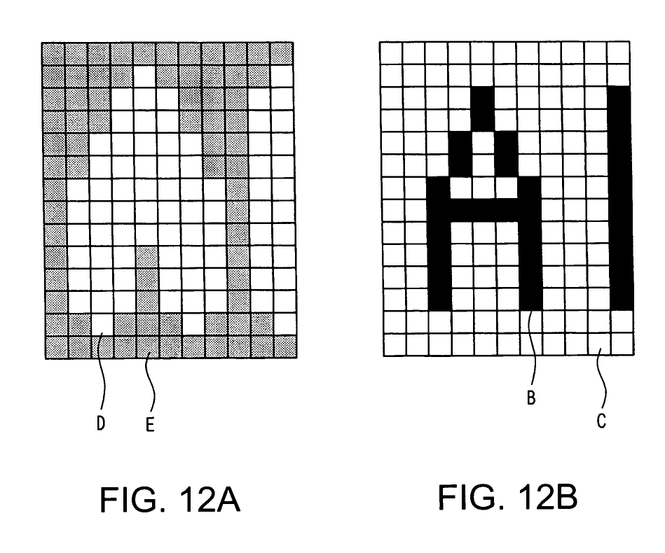

Also, although an example has been described where, as shown in FIG. 6A, the bright color display region C of the character data B included in the contents being displayed on the electrophoresis panel 3 (i.e., the portion superposed on the display region C of the background portion of the characters) is displayed in white on the organic EL display 2, the invention is not limited thereto. The invention may also be configured in such a way that, as shown in FIG. 12A, of the portion superposed on the display region C of the background portion of the characters, only a region E excluding a region D proximate the characters is displayed in white on the organic EL display 2. By configuring the invention in this manner, power consumed in causing the organic EL display 2 to emit white light can be further reduced.

Moreover, although an example has been described where color photographic data is displayed by the organic EL display 2, the invention is not limited thereto. The invention may also be configured to display, for example, a color or monochromatic moving image. By configuring the invention in this manner, the moving image can be displayed at an appropriate speed.

Also, the reflective display that displays in black and white at the rear surface side is not limited to the electrophoresis panel. The reflective display may also be a cholesteric liquid crystal panel, twist ball electronic paper or an electrodeposition display or the like.

Also, although description has been given of an electronic book reader for browsing the contents of an electronic book as the electronic device equipped with the display device of the invention, the electronic device of the invention is not limited thereto. The invention can also be applied to an electronic device such as an electronic notebook, a mobile personal computer, a cellular telephone or a digital still camera.

What is claimed is:

1. A display device including:
a first display disposed on a display screen side of the display device; and
a second display disposed on a rear surface side of the display device;
the first display including:
a self-luminous layer that self-emits desired color lights in response to a first applied voltage; and
a pair of transparent electrodes disposed so as to sandwich the self-luminous layer; and
the second display including:
an electrophoresis layer that displays two colors in response to a second applied voltage.

2. The display device of claim 1, wherein the two-color display comprises a black-and-white display.

3. The display device of claim 1, wherein the self-luminous layer comprises an organic electroluminescence layer.

4. The display device of claim 1, further comprising control means for controlling the display states of the first display and the second display.

5. A display device including:
a first display disposed on a display screen side of the display device;
a second display disposed on a rear surface side of the display device;
the first display including:
a self-luminous layer that self-emits desired color lights in response to a first applied voltage; and
a pair of transparent electrodes disposed so as to sandwich the self-luminous layer;
the second display including:
a reflective display layer that displays two colors in response to a second applied voltage; and
control means for controlling the display states of the first display and the second display, wherein:
the control means causes the first display to display color display data included in display contents and causes the second display to display monochromatic display data included in the display contents.

6. The display device of claim 4, wherein the control means causes the first display to display color display data included in display contents and causes the second display to display monochromatic display data included in the display contents.

7. The display device of claim 5, wherein the control means causes the first display to display color photographic data included in the display contents and causes the second display to display monochromatic photographic data and character data included in the display contents.

8. The display device of claim 5, wherein the control means causes the first display to display the color display data included in the display contents and displays, in a dark color, a portion of the second display superposed on a display region of the color display data.

9. The display device of claim 5, wherein the control means causes the second display to display the character data included in the display contents and sets, to a light-emitting state, a portion of the first display at least substantially superposed on a bright color display region of the character data.

10. The display device of claim 5, further comprising mode selection means for enabling a user to select a power-saving mode, wherein, when the power-saving mode is selected, the control means causes the second display to also display, in two colors, the color display data included in the display contents.

11. The display device of claim 5, wherein when the state where the first display is displaying the color display data included in the display contents passes a set amount of time, the control means automatically moves to a state where the second display is allowed to display, in two colors, the color display data.

12. The display device of claim 5, further comprising incident light amount detecting means for detecting the amount of light incident to the display screen, wherein the control means controls the brightness of the first display in response to the incident light amount.

13. An electronic device including the display device as recited in claim 1.

14. A display method comprising:
causing a display device having a reflective display disposed on a rear surface side of a self-luminous transmissive display to display display contents;
causing the transmissive display to display color display data included in the display contents; and
causing the reflective display to display monochromatic display data included in the display contents.

15. The display method of claim 14, wherein the transmissive display is made to display color photographic data included in the display contents and the reflective display is made to display monochromatic photographic data and character data included in the display contents.

16. The display method of claim 14, wherein the transmissive display is made to display the color display data included in the display contents and a portion of the reflective display superposed on a display region of the color display data is displayed in a dark color.

17. The display method of claim 14, wherein the reflective display is made to display the character data included in the display contents and a portion of the transmissive display at least substantially superposed on a bright color display region of the character data is set to a light-emitting state.

18. The display method of claim 14, wherein when a power-saving mode is selected by a user, the reflective display is also made to display, in two colors, the color display data included in the display contents.

19. The display method of claim 14, wherein when the state where the transmissive display is being made to display the color display data included in the display contents passes a set amount of time, the state is automatically moved to a state where the reflective display is made to display, in two colors, the color display data.
